(19) United States
(12) Patent Application Publication
(10) Pub. No.: US 2016/0059117 A1
(43) Pub. Date: Mar. 3, 2016

(54) GAME CONFIGURATION BASED ON SELECTABLE DIGITAL CONTENT

(71) Applicant: Kobo Incorporated, Toronto (CA)

(72) Inventors: Benjamin Landau, Toronto (CA); Vanessa Ghosh, Toronto (CA)

(21) Appl. No.: 14/529,759

(22) Filed: Oct. 31, 2014

Related U.S. Application Data
(63) Continuation-in-part of application No. 14/470,018, filed on Aug. 27, 2014.

(51) Int. Cl. A63F 9/06; A63F 9/00; A63F 13/67; G06F 3/0484

(52) U.S. Cl. CPC A63F 9/0612; G06F 3/0484; A63F 9/0098; A63F 13/67

(57) ABSTRACT

Game configuration based on selectable digital content. In accordance with a first method embodiment of the present invention, a computer implemented method includes accepting a difficulty level and at least one media title from a user via a graphical user interface and selecting a plurality of words from the at least one media title. The plurality of words corresponds to the difficulty level. The method also includes determining a definition for each of the plurality of words, displaying, on the graphical user interface, a free-form crossword puzzle corresponding to the plurality of words and displaying, on the graphical user interface, the definition for each of the plurality of words. The plurality of words may be relatively unique to the at least one media title.

### RELATED APPLICATIONS

This application is a Continuation-in-Part of co-pending, commonly owned U.S. patent application Ser. No. 14/470,018, filed Aug. 27, 2014, Attorney Docket Number KOBO-0058, entitled “Automatically Generating Reading Recommendations based on Linguistic Difficulty,” to Landau and Givoni, which is hereby incorporated herein by reference in its entirety.

This application is related to co-pending, commonly owned U.S. patent application Ser. No. 14/219,613, filed Mar. 19, 2014, entitled, “Content Based Similarity Detection” to Braziunas et al., which is hereby incorporated herein by reference in its entirety.

This application is related to co-pending, commonly owned U.S. patent application Ser. No. 14/097,078, filed Dec. 4, 2013, Attorney Docket Number KOBO-0033, entitled “System and Method for Automatic Electronic Document Identification,” to Christensen and Braziunas, which is hereby incorporated herein by reference in its entirety.

### FIELD OF INVENTION

Embodiments of the present invention relate to the field of electronic content applications. More specifically, embodiments of the present invention relate to systems and methods for game configuration based on selectable digital content.

### BACKGROUND

In the electronic publications arts, it is often desirable to interact or “engage” with an electronic media in ways that are different from the media's primary application. For example, if the electronic media is an e-book, the primary method of interaction is typically to read the book. Other interactions may include, for example, discussing the book, e.g., in an on-line discussion group, reading related works, learning about the author, answering quizzes about the content, and the like. Such additional engagements allow a reader to interact with a work in a variety of ways, to savor the work over a longer period of time, and generally to increase one's enjoyment of the primary work.

### SUMMARY OF THE INVENTION

Therefore, what is needed are systems and methods for game configuration based on selectable digital content. What is additionally needed are systems and methods for game configuration based on selectable digital content that select terms for inclusion in the game from at least one media title according to a selected difficulty level. A further need exists for systems and methods for game configuration based on selectable digital content that are compatible and complementary with existing systems and methods of electronic book usage. Embodiments of the present invention provide these advantages.

In accordance with a first method embodiment of the present invention, a computer implemented method includes accepting a difficulty level and at least one media title from a user via a graphical user interface and selecting a plurality of words from the at least one media title. The plurality of words corresponds to the difficulty level. The method also includes determining a definition for each of the plurality of words, displaying, on the graphical user interface, a free-form crossword puzzle corresponding to the plurality of words and displaying, on the graphical user interface, the definition for each of the plurality of words. The plurality of words may be relatively unique to the at least one media title.

In accordance with another embodiment of the present invention, an article of manufacture includes a computer readable medium having instructions stored thereon that, responsive to execution by an electronic system, cause the electronic system to perform operations including accepting a difficulty level and at least one media title from a user via a graphical user interface and selecting a plurality of words from the at least one media title. The plurality of words corresponds to the difficulty level. The operations also include determining a definition for each of the plurality of words, displaying, on the graphical user interface, a free-form crossword puzzle corresponding to the plurality of words and displaying, on the graphical user interface, the definition for each of the plurality of words. The operations may further include displaying a completion mark in association with a definition for a completed word in the crossword puzzle.

In accordance with a further embodiment of the present invention, an electronic system includes one or more processors, a memory coupled to the one or more processors and a graphical user interface coupled to the one or more processors. The electronic system is configured to accept a difficulty level and at least one media title from a user via the graphical user interface and select a plurality of words from the at least one media title. The plurality of words corresponds to the difficulty level. The electronic system is further configured to determine a definition for each of the plurality of words, display, on the graphical user interface, a free-form crossword puzzle corresponding to the plurality of words and display, on the graphical user interface, the definition for each of the plurality of words.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary graphical user interface (GUI), in accordance with embodiments of the present invention.

FIG. 3 illustrates an exemplary graphical user interface (GUI) of a game-initiation screen for a game configured based on selectable content, in accordance with embodiments of the present invention.

FIG. 4 illustrates an exemplary graphical user interface (GUI) of a game configured based on selectable content, in accordance with embodiments of the present invention.

FIG. 5 illustrates a method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., method 500) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “normalizing” or “creating” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the terms “book,” “e-book” or “electronic book” are used to refer to or to describe a digital instance of a textual, or primarily text-based content. Such content may commonly be known or referred to as a “book,” “e-book,” “magazine,” “article,” “story” or the like.

### Game Configuration Based on Selectable Digital Content

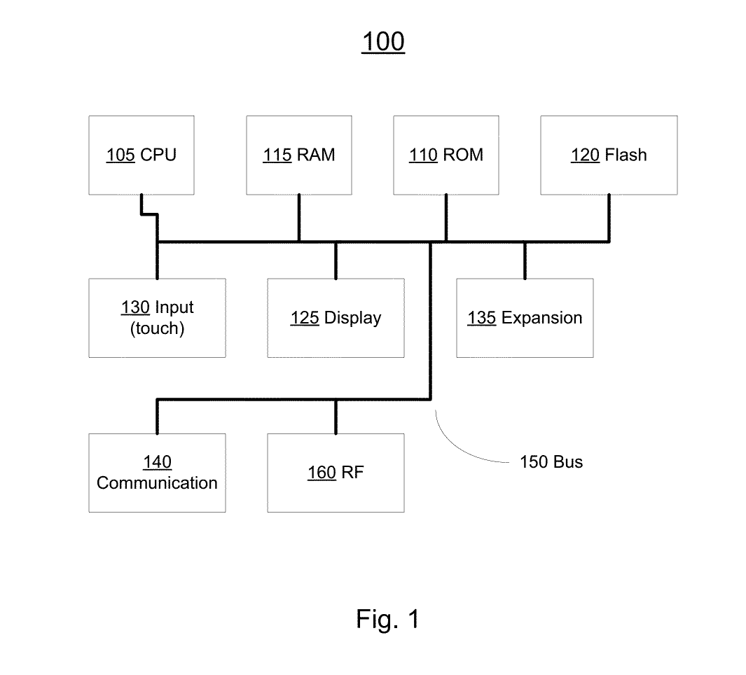

FIG. 1 illustrates an exemplary block diagram of an exemplary electronic system 100, which may be used as a platform to implement embodiments of the present invention. Electronic system 100 may be battery-powered, in some embodiments. In some embodiments, electronic system 100 may be a “server” computer. Electronic system 100 includes an address/data bus 150 for communicating information, a central processor 105 functionally coupled with the bus for processing information and instructions. Central processor 105 may comprise multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the Electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

A touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may consist of signals substantially compliant with the signals of bus 150.

A wide variety of well known devices may be attached to electronic system 100 via the bus 150 and/or expansion interface 135. Examples of such devices include without limitation rotating magnetic memory devices, flash memory devices, digital cameras, wireless communication modules, digital audio players and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

In accordance with embodiments of the present invention, users of electronic media, e.g., e-books, may continue to engage with an enjoyable media long after they've finished a primary interaction with such media, e.g., reading a book. A user is able to select a difficulty level, e.g., “easy” or “difficult,” and choose a book from their e-library. The e-library may be hosted on the local device, in the “cloud,” or any combination thereof. Based upon those selections, a crossword puzzle or similar game is configured and generated by the e-reader program, e.g., an “app,” and presented at the user's e-reading device.

In accordance with embodiments of the present invention, the words, or answers to the puzzle, at drawn from the selected item, e.g., a specific e-book, in the user's library. As each book is made up of a unique set of words, each puzzle will be different. Difficulty level may be determined in accordance with the disclosures of commonly-owned U.S. patent application Ser. No. 14/470,018, filed Aug. 27, 2014, Attorney Docket Number KOBO-0058, entitled “Automatically Generating Reading Recommendations based on Linguistic Difficulty,” to Landau and Givoni, which is hereby incorporated herein by reference in its entirety.

The puzzle-generating engine may avoid selecting common words or phrases, such as “the,” “some” or “once upon a time.” Unique terms, e.g., terms appearing in the selected work that appear rarely in other works, may be prioritized for inclusion in the puzzle. Uniqueness may be determined, for example, in accordance with the disclosures of commonly-owned U.S. patent application Ser. No. 14/219,613, Mar. 19, 2014, entitled, “Content Based Similarity Detection” to Braziunas et al., which is hereby incorporated herein by reference in its entirety. For example, “uniqueness” may be seen as the inverse or complement of “similarity.”

Unique terms selected for inclusion in the puzzle may also be determined, for example, in accordance with the disclosures of commonly-owned U.S. patent application Ser. No. 14/097,078, filed Dec. 4, 2013, Attorney Docket Number KOBO-0033, entitled “System and Method for Automatic Electronic Document Identification,” to Christensen and Braziunas, which is hereby incorporated herein by reference in its entirety.

Clues for the words may be created from the media device's built-in dictionary and/or on-line public and/or private dictionaries, or any suitable combination thereof.

In addition to puzzles based on a single media, in accordance with embodiments of the present invention, a puzzle may be generated using terms from more than one media, or a user's entire electronic library, for example, stored in a cloud account.

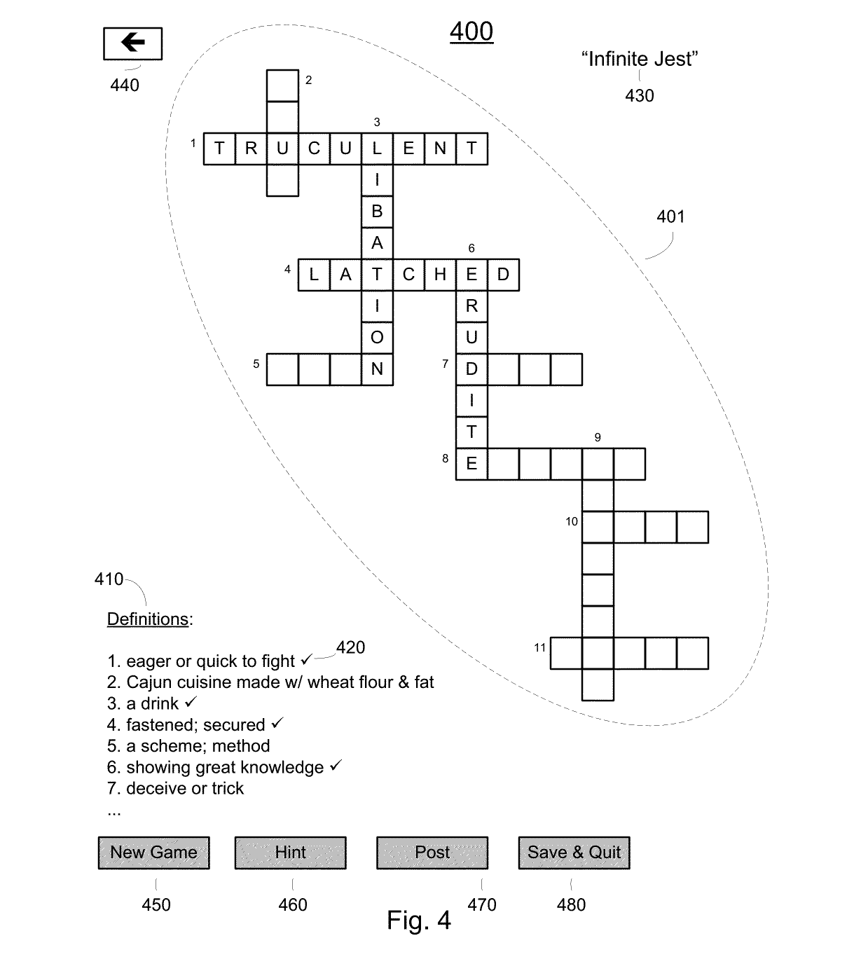

A well-known form of word puzzle is known as or referred to as a “free-form” or “crisscross” style crossword puzzle. Such puzzles have a “snaking” style in which each word only connects to a few other words, rather than having most letters intersect other words, as is common for “grid” style crossword puzzles. Item 401 of FIG. 4, further described below, illustrates an exemplary free-form crossword puzzle, in accordance with embodiments of the present invention.

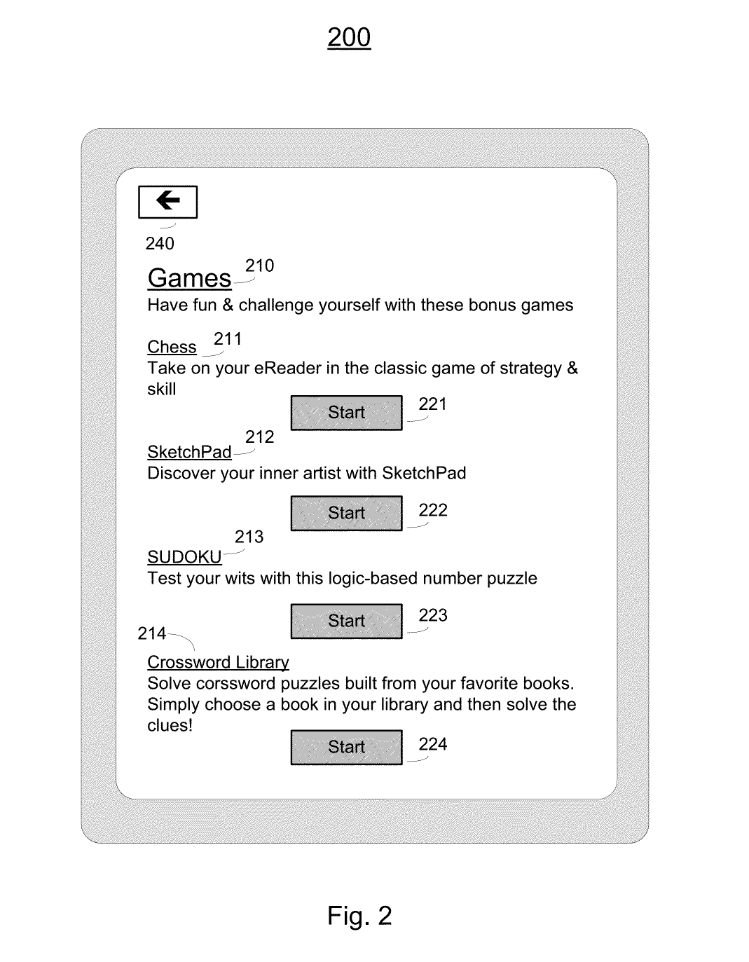

FIG. 2 illustrates an exemplary graphical user interface (GUI) 200, in accordance with embodiments of the present invention. Graphical user interface 200 may be displayed on an electronic system 100 (FIG. 1), for example, a smart phone running an application or a dedicated e-reader. Graphical user interface 200 may be used to select from a plurality of “features” or games available to a user of electronic system 100. More particularly, graphical user interface 200 enables a user to initiate generation of a game based on selectable digital content, in accordance with embodiments of the present invention.

Graphical user interface 200 displays a title 210. Graphical user interface 200 comprises a list of a plurality of “features” or games available to a user of electronic system 100 (FIG. 1). It is appreciated that the exemplary list is not limiting, and there may be more than the indicated number and types of games available, e.g., displayed on a plurality of pages. Graphical user interface 200 displays four games: chess 211, sketchpad 212, Sudoku 213 and crossword library 214. Each game 211 through 214 has an associated textual description (not labeled). Graphical user interface 200 also comprises a “launch” or “start” button corresponding to each listed game, for example, touching start button 221 will launch chess 211, touching start button 222 will launch sketchpad 212, touching start button 223 will launch Sudoku 213, and touching start button 224 will launch crossword library 214. Graphical user interface 200 further comprises a “back” or “return” button 240. Touching “back” button 240 returns a display to a previous screen.

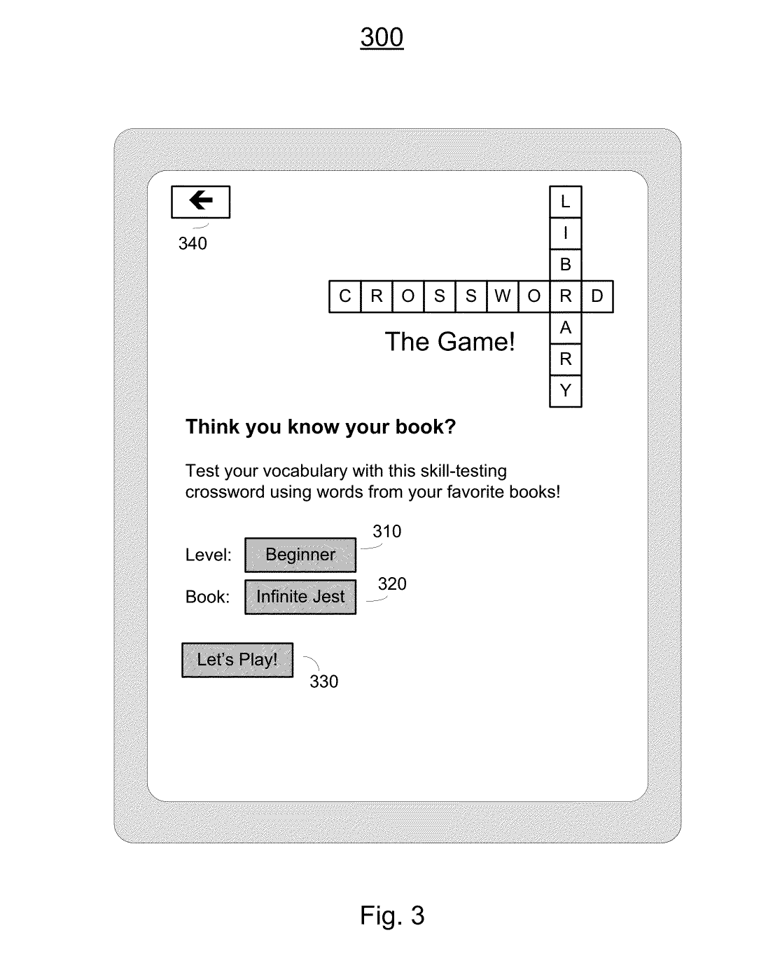

Touching start button 224 will initiate the game crossword library 214, presenting graphical user interface 300 of FIG. 3, further described below.

FIG. 3 illustrates an exemplary graphical user interface (GUI) of a game-initiation screen 300 for a game configured based on selectable content, in accordance with embodiments of the present invention. Game initiation screen 300 accepts parameter information from a user to guide the configuration of a crossword puzzle, in accordance with embodiments of the present invention. Game-initiation screen 300 comprises a difficulty level selection button 310. Level selection button 310 allows a user to select a difficulty level for the game. Difficulty levels may include, for example, “beginner,” “medium,” “expert,” “master,” and/or “cruciverbalist.”

Game-initiation screen 300 also comprises a field 320 for selection of a media title. A user may enter the title via any suitable technique, including, for example, textual entry via handwriting recognition or keyboard entry. In addition, a user may scroll, e.g., by touch gesture or directional keys, through a listing of media available in a user's media library. The media library may be stored locally, in a cloud, or any suitable combination thereof. In addition, game-initiation screen 300 comprises a “launch” or “start” button 330, for example, labeled “Let's Play.” Touching button 330 causes an electronic system, which may include systems beyond electronic system 100 (FIG. 1), to generate a game based on selectable digital content, in accordance with embodiments of the present invention. Graphical user interface 300 further comprises a “back” or “return” button 340. Touching “back” button 340 returns a display to a previous screen.

After selecting a set of media title(s), touching button 330 will generate a game based on selectable digital content, in accordance with embodiments of the present invention. FIG. 4, further described below, illustrates an exemplary graphical user interface (GUI) 400 of such a resulting game.

FIG. 4 illustrates an exemplary graphical user interface (GUI) 400 of a game configured based on selectable content, in accordance with embodiments of the present invention. Graphical user interface 400 may be displayed on an electronic system 100 (FIG. 1), for example, a smart phone running an application or a dedicated e-reader. Graphical user interface 400 comprises an exemplary free-form crossword puzzle 401. As illustrated, free-form crossword puzzle 401 has been partially completed. For example, the blocks for answers one, two, three and six have been filled in. The blocks for answers nine, ten and 11 are completely blank. The blocks for answers two, five, seven and eight are partially completed. It is appreciated that many of the illustrated blocks in free-form crossword puzzle 401 do not intersect with other answer words.

The blocks of free-form crossword puzzle 401 may be filled by any suitable technique. For example, a user may form the character in the box by use of a stylus device or a finger, e.g., using a touch-sensitive feature of electronic system 100 (FIG. 1). A user may indicate a block, e.g., by touching it, and use an on or off screen keyboard (not shown) to select a desired letter. A user may indicate a block via a touch action, and speak a character to be recognized by voice recognition. A block may be identified by a cursor, and navigated to by directional buttons.

Graphical user interface 400 also comprises a list 410 of definitions or clues for solving free-form crossword puzzle 401. The answers, e.g., the words that go in the blocks of free-form crossword puzzle 401, are selected from a user's chosen media. The definitions 410 are determined from a device's local dictionary, from on-line dictionaries, or any suitable combination thereof. When an answer is completely filled in, e.g., answer number one, “truculent,” a completion mark 420, e.g., a “check” mark, is appended to the definition to serve as a visual reminder of completion.

Graphical user interface 400 may comprise a media title 430. For example, media title 430 lists the one or more media titles from which the terms in the free-form crossword puzzle 401 are selected. Graphical user interface 400 further comprises a “back” or “return” button 440. Graphical user interface 400 comprises a plurality of buttons related to game play, including, for example, a “new game” button 450, which may terminate an existing game and generate a new game, a “hint” button 460, which may provide a different, e.g., easier, definition and/or provide a letter of the answer in an identified block, a “post” button 470, which may post information of the puzzle to a variety of social media sites, and a “save and quit” button 480, which may save a completed or partially completed game to be recalled later, and terminate the application.

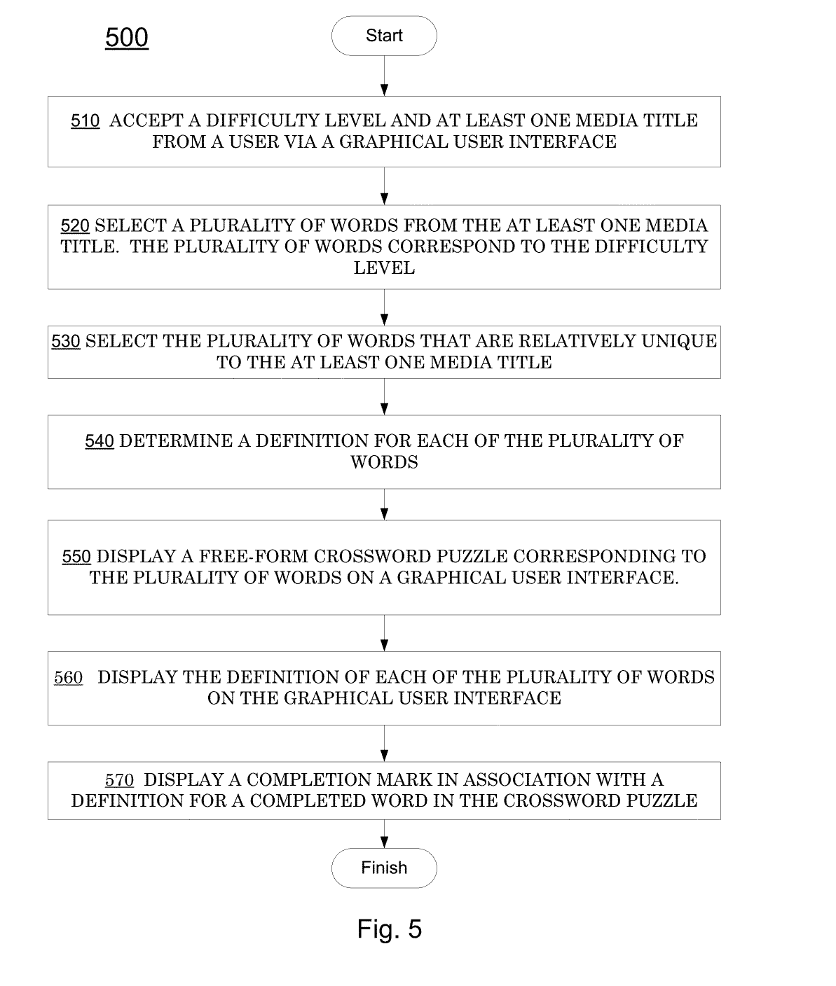

FIG. 5 illustrates an exemplary computer implemented method 500 of configuring a game based on selectable digital content, in accordance with embodiments of the present invention. In 510, a difficulty level and at least one media title are accepted from a user via a graphical user interface, for example, graphical user interface 300 of FIG. 3. The media title(s) may be restricted to those titles in a user's media library. In 520 a plurality of words are selected from the media title(s). The plurality of words corresponds to the difficulty level. Difficulty level may be determined in any suitable manner, for example, in accordance with the disclosures of commonly-owned U.S. patent application Ser. No. 14/470,018, filed Aug. 27, 2014, Attorney Docket Number KOBO-0058, entitled “Automatically Generating Reading Recommendations based on Linguistic Difficulty,” to Landau and Givoni, which is hereby incorporated herein by reference in its entirety.

In optional 530, the plurality of words may further be selected so as to be relatively unique to the selected media title(s). A measure of uniqueness may be determined in any suitable manner, for example, in accordance with the disclosures of commonly-owned U.S. patent application Ser. No. 14/219,613, Mar. 19, 2014, entitled, “Content Based Similarity Detection” to Braziunas et al., which is hereby incorporated herein by reference in its entirety. For example, the word “roux,” the answer to clue number two in exemplary free-form crossword puzzle 401 of FIG. 4, is a relatively uncommon word and may be relatively unique to the exemplary book “Infinite Jest” (David Foster Wallace), along with cook books and books dealing with, e.g., southern Louisiana. A determination of uniqueness may determine that a term is absolutely unique, e.g., the term does not appear in any other media within a user's media library, common, e.g., the term appears in a majority of other media within a user's media library, or relatively unique, e.g., the term appears in less than a majority of other media within a user's media library. Relative uniqueness may be determined by another percentage of media in a user's library sharing the term, e.g., 40%, 30%, 20%, 10%, etc. A uniqueness measure may ignore occurrences of a term within a media series, in accordance with embodiments of the present invention.

In 540, a definition is determined for each of the plurality of selected words. The definition may be determined from a local, e.g., on the device, dictionary, or from one or more on-line dictionaries, from a media's glossary, endnotes and/or any suitable combination thereof.

In 550, a free-form crossword puzzle corresponding to the plurality of words is displayed on a graphical user interface, e.g., graphical user interface 400 of FIG. 4. The number of the plurality of words may be selected or limited to ensure that the crossword puzzle and the list of definitions fits on a single displayed image. Such a number may vary based on display size and/or resolution. The displayed crossword puzzle is operable to accept alphanumeric input into boxes of the crossword puzzle. Given the selected plurality of words, the puzzle may be generated by any suitable technique. In 560, the definition of each of the plurality of words is displayed on the graphical user interface, e.g., graphical user interface 400 of FIG. 4.

In optional 570, a completion mark, e.g., completion mark 420 of FIG. 4, is displayed in association with a definition for a completed word in the displayed crossword puzzle.

Embodiments in accordance with the present invention provide systems and methods for game configuration based on selectable digital content. In addition, embodiments in accordance with the present invention provide systems and methods for game configuration based on selectable digital content that select terms for included in the game from at least one media title according to a selected difficulty level. Further, embodiments in accordance with the present invention provide systems and methods for game configuration based on selectable digital content that are compatible and complementary with existing systems and methods of electronic book usage.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
accepting a difficulty level and at least one media title from a user via a graphical user interface;
selecting a plurality of words from said at least one media title, wherein said plurality of words corresponds to said difficulty level;
determining a definition for each of said plurality of words;
displaying, on said graphical user interface, a free-form crossword puzzle corresponding to said plurality of words; and
displaying, on said graphical user interface, said definition for each of said plurality of words.

2. The computer implemented method of claim 1 further comprising:
selecting a plurality of words from said at least one media title, wherein said plurality of words are relatively unique to said at least one media title.

3. The computer implemented method of claim 2 further comprising:
selecting a plurality of words from said at least one media title, wherein said plurality of words are absolutely unique to said at least one media title.

4. The computer implemented method of claim 1 further comprising:
displaying a completion mark in association with a definition for a completed word in said crossword puzzle.

5. The computer implemented method of claim 1 wherein said free-form crossword puzzle is operable to accept alphanumeric input into boxes of said free-form crossword puzzle.

6. The computer implemented method of claim 1 wherein said at least one media title is restricted to those titles in a user's media library.

7. The computer implemented method of claim 1 wherein the number of said plurality of words is determined so that said free-form crossword puzzle and said definition for each of said plurality of words fit on a single page of said graphical user interface.

8. An article of manufacture including a computer readable medium having instructions stored thereon that, responsive to execution by an electronic system, cause said electronic system to perform operations comprising:
accepting a difficulty level and at least one media title from a user via a graphical user interface;
selecting a plurality of words from said at least one media title, wherein said plurality of words corresponds to said difficulty level;
determining a definition for each of said plurality of words;
displaying, on said graphical user interface, a free-form crossword puzzle corresponding to said plurality of words; and
displaying, on said graphical user interface, said definition for each of said plurality of words.

9. The article of manufacture of claim 8 wherein said operations further comprise:
selecting a plurality of words from said at least one media title, wherein said plurality of words are relatively unique to said at least one media title.

10. The article of manufacture of claim 9 wherein said wherein said operations further comprise:
selecting a plurality of words from said at least one media title, wherein said plurality of words are absolutely unique to said at least one media title.

11. The article of manufacture of claim 8 wherein said operations further comprise:
displaying a completion mark in association with a definition for a completed word in the crossword puzzle.

12. The article of manufacture of claim 8 wherein said free-form crossword puzzle is operable to accept alphanumeric input into boxes of said free-form crossword puzzle.

13. The article of manufacture of claim 8 wherein said at least one media title is restricted to those titles in a user's media library.

14. The article of manufacture of claim 8 wherein the number of said plurality of words is determined so that said free-form crossword puzzle and said definition for each of said plurality of words fit on a single page of said graphical user interface.

15. An electronic system comprising:
one or more processors;
a memory coupled to said one or more processors, wherein said memory comprises a plurality of electronic books;
a graphical user interface coupled to said one or more processors;
wherein said electronic system is configured to:
accept a difficulty level and at least one media title from a user via said graphical user interface;
select a plurality of words from said at least one media title, wherein said plurality of words corresponds to said difficulty level;
determine a definition for each of said plurality of words;
display, on said graphical user interface, a free-form crossword puzzle corresponding to said plurality of words; and
display, on said graphical user interface, said definition for each of said plurality of words.

16. The electronic system of claim 15 further configured to:
select a plurality of words from said at least one media title, wherein said plurality of words are relatively unique to said at least one media title.

17. The electronic system of claim 16 further configured to:
display a completion mark in association with a definition for a completed word in the crossword puzzle.

18. The electronic system of claim 16 wherein said graphical user interface is operable to accept alphanumeric input into boxes of said free-form crossword puzzle.

19. The electronic system of claim 15 further configured to:
restrict said at least one media title to those titles in a user's media library.

20. The electronic system of claim 15 further configured to:
fit said free-form crossword puzzle and said definition for each of said plurality of words on a single page of said graphical user interface.
